(19) United States
(12) Patent Application Publication
(10) Pub. No.: US 2015/0377569 A1
(43) Pub. Date: Dec. 31, 2015

(54) Media Pads for Gas Turbine

(71) Applicant: General Electric Company, Schenectady, NY (US)

(72) Inventors: Jianmin Zhang, Greer, SC (US); Brad Aaron Kippel, Greer, SC (US)

(21) Appl. No.: 14/318,891

(22) Filed: Jun. 30, 2014

(51) Int. Cl. F28F 25/08; F02C 7/143; F02C 7/04

(52) U.S. Cl. CPC F28F 25/087; F02C 7/04; F02C 7/143; F05D 2260/14; F05D 2260/232

(57) ABSTRACT

The present application provides an inlet heat exchanger for cooling an inlet air flow in a compressor of a gas turbine engine. The inlet air exchanger may include a media pad with a number of media sheets having a substantially three-dimensional contoured shape made from non-woven synthetic fibers and a heat exchange medium flowing from a top to a bottom of the media pad to exchange heat with the inlet air flow.

### TECHNICAL FIELD

The present application and the resultant patent relate generally to gas turbine engines and more particularly relates to a non-woven, synthetic fiber media pad with surface contours for improved water flow distribution and evaporation for power augmentation.

### BACKGROUND OF THE INVENTION

Gas turbines engines are widely utilized in fields such as power generation. A conventional gas turbine engine includes a compressor for compressing ambient air, a combustor for mixing the compressed air with a flow of fuel and combusting the mixture, and a turbine that is driven by the combustion mixture to produce power and exhaust gases. Various strategies are known for increasing the amount of power that a gas turbine engine may be able to produce. One method of increasing the power output is by cooling the ambient air upstream of the compressor. Such cooling may cause the air to have a higher density, thereby creating a higher mass flow rate into the compressor. The higher mass flow rate into the compressor allows more air to be compressed so as to allow the gas turbine to produce more power. Additionally, cooling the ambient air generally may increase the overall efficiency of the gas turbine engine in hot environments.

Various systems and methods may be utilized to cool the ambient air entering a gas turbine engine. For example, heat exchangers may be utilized to cool the ambient air through latent cooling or through sensible cooling. Such heat exchangers often may utilize a media pad to facilitate the cooling of the ambient air. These media pads may allow heat and/or mass transfer between the ambient air and a coolant flow. The ambient air interacts with the coolant flow in the media pad for heat exchange therewith.

Known media pads for use in heat exchangers may be formed from, for example, cellulose fibers and the like. Cellulose fiber-based media pads generally include a stiffening agent designed to maintain the structural integrity of the media pad when a coolant, such as water, flows through the media pad. Typical geometries for cellulose fiber-based media pads, however, generally may not suitable in situations requiring a high volume of coolant due to the potential risk of water carryover. Further, cellulose fiber-based media pads may be particularly sensitive to the quality of the coolant flowing therethrough. Specifically, the media pad may require the use of a “fouled” coolant rather than a clean or a pure coolant for the media pad to perform properly. For example, pure water from a desalination process may dissolve the stiffening agent typically used with cellulose fiber-based media pads and may lead to the collapse of the media pad.

Other known media pads may be formed from non-porous, solid plastic materials. These media pads generally are not able to distribute evenly and fully the flow of coolant throughout the surface area of the pads. Such incomplete distribution may inhibit efficient cooling of the ambient air. Further, a number of dry spots may develop and lead to hot streaks of air. Such hot streaks may be detrimental to the operation of the gas turbine compressor. Additionally, these media pads may be unable to retain the coolant at relatively higher air flow velocities.

There is therefore a need for a media pad that provides more efficient cooling while not being significantly sensitive to coolant quality. Additionally, such a media pad may maintain structural integrity when a high volume of coolant is flowed therethrough. Further, such a media pad may reduce or prevents dry spots and resulting hot streaks. Finally, such a media pad may retain coolant at relatively higher air flow velocities.

### SUMMARY OF THE INVENTION

The present application and the resultant patent thus provide an inlet heat exchanger for cooling an inlet air flow in a compressor of a gas turbine engine. The inlet air exchanger may include a media pad with a number of media sheets having a substantially three-dimensional contoured shape made from non-woven synthetic fibers and a heat exchange medium flowing from a top to a bottom of the media pad to exchange heat with the inlet air flow.

The present application and the resultant patent further provide a method of cooling an inlet air flow into a gas turbine engine. The method may include the steps of positioning a media pad with a substantially three-dimensional contoured shape made from non-woven synthetic fibers about an inlet of the gas turbine engine, flowing pure water from a top to a bottom of the media pad, and exchanging heat between the inlet air flow and the flow of pure water.

The present application and the resultant patent further provide an inlet heat exchanger for cooling an inlet air flow in a compressor of a gas turbine engine. The inlet heat exchanger may include a media pad with a first media sheet and a second media sheet and a flow of water from a top to a bottom of the media pad to exchange heat with the inlet air flow therethrough. The first media sheet and the second media sheet may include a substantially three-dimensional contoured shape made from non-woven synthetic fibers. The first media sheet and the second media sheet may be substantially similar in shape.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine system with inlet cooling.

FIG. 2 is a perspective via of a media pad as may be described herein with the media sheets stack on top of each other.

FIG. 3 is a perspective view of the media pad of FIG. 2 with the media sheets separated.

FIG. 4 is a top plan view of the media pad of FIG. 2.

FIG. 5 is a side view of the media pad of FIG. 2 in use with air and water flows therethrough.

FIG. 6 is a perspective view of the media pad of FIG. 2.

### DETAILED DESCRIPTION

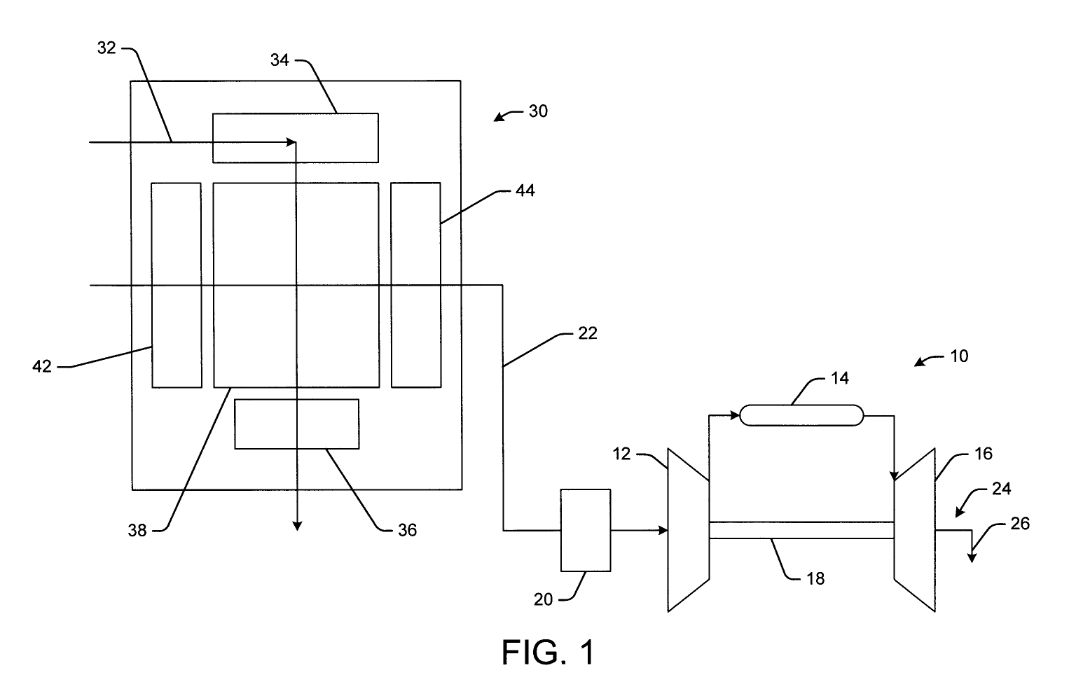

FIG. 1 is a schematic diagram of an example of a gas turbine engine 10. The engine 10 may include a compressor 12, a combustor 14, and a turbine 16. Further, the gas turbine engine 10 may include a number of the compressors 12, the combustors 14, and the turbines 16. The compressor 12 and the turbine 16 may be coupled by a shaft 18. The shaft 18 may be a single shaft or a number of shaft segments coupled together to form the shaft 18.

The engine 10 further may include a gas turbine inlet 20. The inlet 20 may be configured to accept an inlet flow 22. For example, the inlet 20 may be in the form of a gas turbine inlet house and the like. Alternatively, the inlet 20 may be any portion of the engine 10, such as any portion of the compressor 12 or any apparatus upstream of the compressor 12, which may accept the inlet flow 22. The inlet flow 22 may be ambient air and may be conditioned or unconditioned.

The engine 10 further may include an exhaust outlet 24. The exhaust outlet 24 may be configured to discharge a gas turbine exhaust flow 26. The exhaust flow 26 may be directed to a heat recovery steam generator (not shown). Alternatively, the exhaust flow 26 may be, for example, directed to an absorption chiller (not shown), directed to provide any type of useful work, or dispersed into the ambient air in whole or in part.

The engine 10 further may include a heat exchanger 30. The heat exchanger 30 may be configured to cool the inlet flow 22 before entry into the compressor 12. For example, the heat exchanger 30 may be disposed in the gas turbine inlet 20 or may be upstream or downstream of the gas turbine inlet 20. The heat exchanger 30 may allow the inlet flow 22 and a heat exchange medium 32 to flow therethrough. The heat exchanger 30 thus may facilitate the interaction of the inlet flow 22 and the heat exchange medium 32 so as to cool the inlet flow 22 before it enters the compressor 12. The heat exchange medium 32 may be water or any suitable type of fluid flow.

The heat exchanger 30 may be a direct-contact heat exchanger 30. The heat exchanger 30 may include a heat exchange medium inlet 34, a heat exchange medium outlet 36, and a media pad 38 therebetween. The heat exchange medium 32 may flow through the inlet 34 to the media pad 38. The inlet 34 may be a nozzle, a number of nozzles, a manifold with an orifice or a number of orifices, and the like. The outlet 36 may accept the heat exchange medium 32 exhausted from the media pad 38. The outlet 36 may be a sump disposed downstream of the media pad 38 in the direction of the flow of the heat exchange medium 32. The heat exchange medium 32 may be directed in a generally or approximately downward direction from the inlet 34 through the media pad 38 while the inlet flow 22 may be directed through the heat exchanger 30 in a direction generally or approximately perpendicular to the direction of flow of the heat exchange medium 32.

A filter 42 may be disposed upstream of the media pad 38 in the direction of inlet flow 22. The filter 42 may be configured to remove particulates from the inlet flow 22 so as to prevent the particulates from entering into the system 10. Alternatively, the filter 42 may be disposed downstream of the media pad 38 in the direction of inlet flow 22. A drift eliminator 44 may be disposed downstream of the media pad 38 in the direction of inlet flow 22. The drift eliminator 44 may act to remove droplets of the heat exchange medium 32 from the inlet flow 22 prior to the inlet flow 22 entering the system 10.

The heat exchanger 30 may be configured to cool the inlet flow 22 through latent or evaporative cooling. Latent cooling refers to a method of cooling where heat is removed from a gas, such as air, so as to change the moisture content of the gas. Latent cooling may involve the evaporation of a liquid at approximate ambient wet bulb temperature to cool the gas. Specifically latent cooling may be utilized to cool a gas to near its wet bulb temperature.

Alternatively, the heat exchanger 30 may be configured to chill the inlet flow 22 through sensible cooling. Sensible cooling refers to a method of cooling where heat is removed from a gas, such as air, so as to change the dry bulb and wet bulb temperatures of the air. Sensible cooling may involve chilling a liquid and then using the chilled liquid to cool the gas. Specifically, sensible cooling may be utilized to cool a gas to below its wet bulb temperature.

It should be understood that latent cooling and sensible cooling are not mutually exclusive cooling methods. Rather, these methods may be applied either exclusively or in combination. It should further be understood that the heat exchanger 30 described herein is not limited to latent cooling and sensible cooling methods, but may cool, or heat, the inlet flow 22 through any suitable cooling or heating method as may be desired.

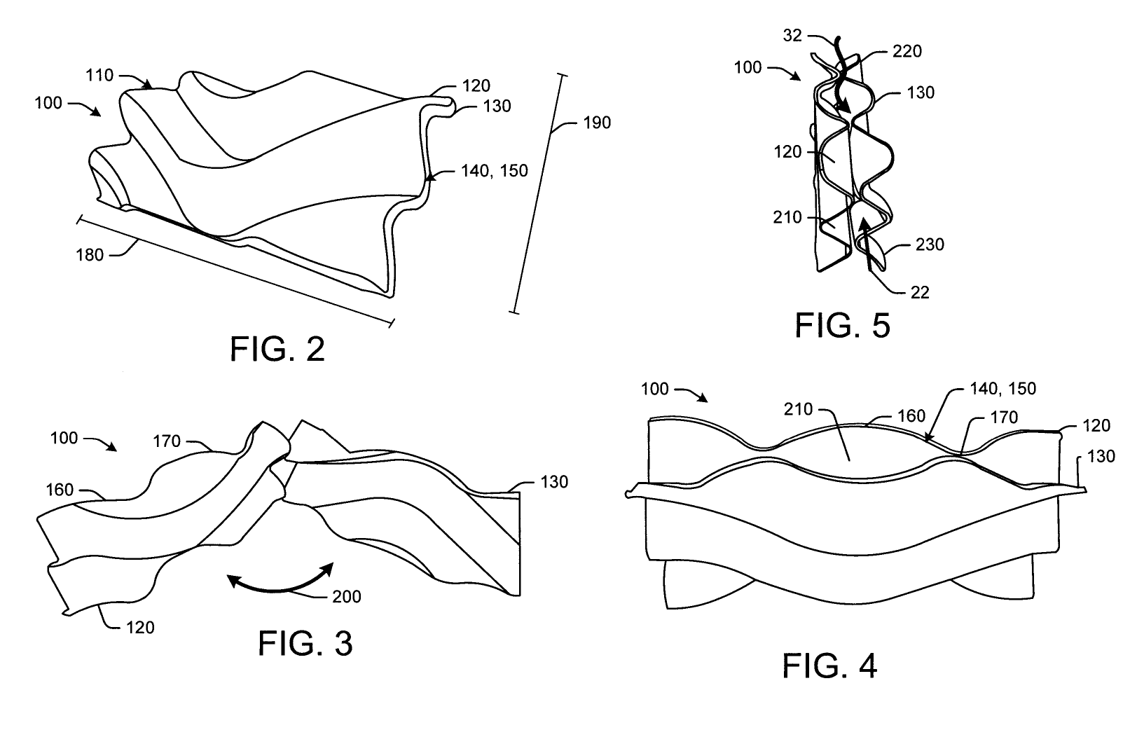

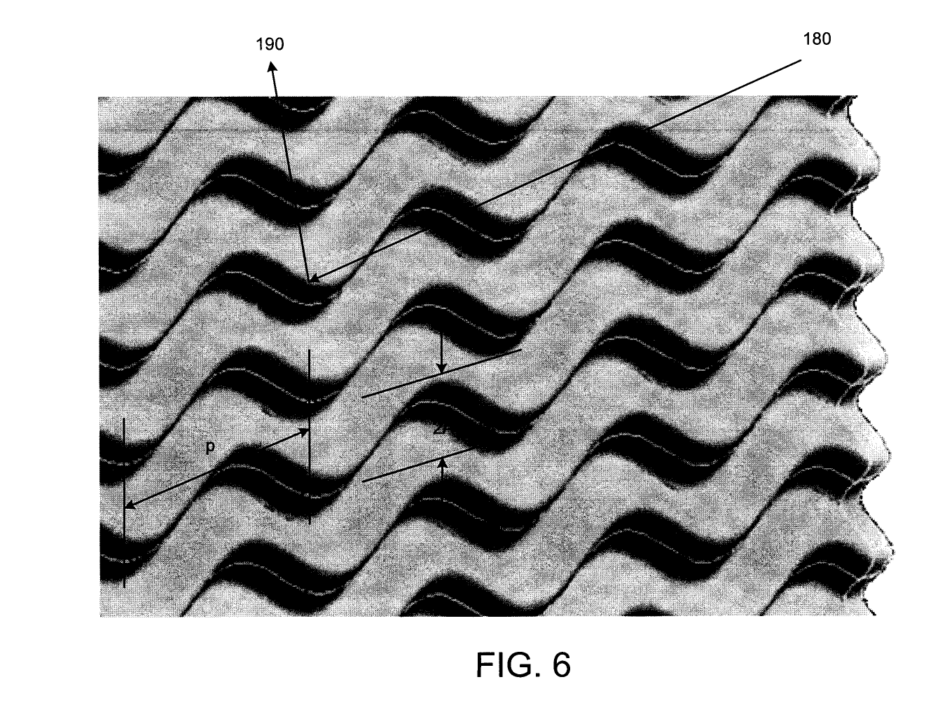

FIGS. 2-6 show an example of a media pad 100 as may be described herein for use as an inlet heat exchanger 105 and the like. The media pad 100 may include at least a pair of media sheets 110. In this example, a first media sheet 120 and a second media sheet 130 are shown although additional sheets may be used herein. The media sheets 110 may have a substantially three-dimensional contoured shape 140. The contoured shape 140 may be a substantially sinusoidal shape 150 with a number of repeating peaks 160 and valleys 170 extending both along a length 180 or a first direction and a width 190 or a second direction.

Specifically, the three-dimensional contoured shape 140 may be formed by sweeping the sinusoidal profile along the length or the first direction 180. The edge profile along the length or the first direction 180 thus may be defined as a curvature shape as opposed to a straight line. The sinusoidal profile may have variable wave pitches. The ratio of pitch (P) to amplitude (A) along the length or the first direction may vary from about one (1) to about (5). The width or the second direction 190 may be defined as a sinusoidal sweeping path. The ratio of pitch to amplitude along the width or the second direction 190 may be about two (2) to about six (6). Other ratios may be used herein.

The contoured shape 140 as well as the sinusoidal shape 150 may vary. The media pad 100 may have any suitable size, shape, or configuration. Both the length or the first direction 180 and the width or the second direction 190 may be about two inches (about five centimeters) long although any suitable dimension may be used herein. The length or the first direction 180 may be oriented substantially parallel to the air flow 22. The width or the second direction 190 may be substantially in line with the general flow direction of the heat exchange medium 32. The length or the first direction 180 also may have an orthogonal position with respect to the width 190 or at an angle. The angle may be between about zero degrees and about ninety degrees although other positions may be used herein. Other components and other configuration may be used herein.

The media sheets 110 may be thermally formed from non-woven synthetic fibers with hydrophilic surface enhancements. For example, the non-woven synthetic fibers may include polyethylene terephthalate (PET), polytrimethylene terephthalate (PTT), and the like. The hydrophilic surface enhancements may include the application of a strong alkaline treatment under high processing temperatures, polyvinyl alcohol in an alkaline medium, and the like. Other materials may be used herein. The media sheets 110 may be wetable so as to accept, absorb, flow, and distribute the heat exchange medium 32 through the surface area thereof. The media sheets 110 may be utilized with different types of heat exchange mediums 32. For example, the heat exchange medium 32 may be pure water without requiring any fouling. Specifically, the media sheets 110 may maintain their structural integrity when provided with a high volume of the heat exchange medium 38. Other types of fluids may be used herein.

As is shown in FIG. 2, the first media sheet 120 and the second media sheet 130 may be substantially similar in shape. In use, however, the media sheets 110 may be separated as in FIG. 3 and positioned face-to-face 200 as is shown in FIGS. 4 and 5. The peaks 160 of one sheet may align with the valleys 170 of the other sheet. This face-to-face position 200 thus forms a number of airflow passages 210. The airflow passages 210 may allow the inlet flow 22 to flow therethrough. At the same time, the heat exchange medium 32 may flow from a top 220 of the media sheets 110 to a bottom 230. As is shown in FIG. 5, the inlet flow 22 comes in contact with the heat exchange medium 32 for heat exchange therewith. The media sheets 110 may be fully wetted by the flow of the heat exchange medium 32. Due to the twisting and swirling airflows generated between the media sheets 110, the heat exchange medium 32 may evaporate into the inlet flow 22 so as to reduce the temperature of the heat exchange medium 32 to around the inlet air wet bulb temperature. Specifically, the twisting and swirling airflows increase heat and mass transfer therethrough. The heat exchange medium 32 may flow through the media sheets 110 at up to about fifteen gallons per square foot (about 611 liters per square meter) or so. Other flow rates may be used herein.

The media pad 100 described herein thus balances the need for overall structural strength, water distribution, and effective heat-mass transfer so as to maximize the overall evaporative cooling rate. The media pad 100 thus may provide effective inlet cooling for hot day power augmentation. Moreover, the elimination of the water treatment equipment with respect to the use of a fouled coolant and the like may reduce overall costs.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. An inlet heat exchanger for cooling an inlet air flow in a compressor of a gas turbine engine, comprising:
a media pad;
the media pad comprising a plurality of media sheets with a substantially three-dimensional contoured shape made from non-woven synthetic fibers; and
a heat exchange medium;
the heat exchange medium flowing from a top to a bottom of the media pad to exchange heat with the inlet air flow.

2. The inlet heat exchanger of claim 1, wherein the substantially three-dimensional contoured shape comprises a substantially sinusoidal shape extending in a first direction and a second direction.

3. The inlet heat exchanger of claim 2, wherein the substantially sinusoidal shape comprises a plurality of peaks and valleys extending in the first direction with a pitch to amplitude ratio of about one (1) to about five (5) and the second direction with the pitch to amplitude ratio of about two (2) to about six (6).

4. The inlet heat exchanger of claim 2, wherein the first direction and the second direction comprise an orthogonal position or any angle between zero degrees and ninety degrees.

5. The inlet heat exchanger of claim 1, wherein the non-woven synthetic fibers are wetable for a uniform water distribution therethrough.

6. The inlet heat exchanger of claim 1, wherein the non-woven synthetic fibers comprise a polyethylene terephthalate (PET) or a polytrimethylene terephthalate (PTT).

7. The inlet heat exchanger of claim 1, wherein the non-woven synthetic fibers comprise a hydrophilic surface enhancement.

8. The inlet heat exchanger of claim 7, wherein the hydrophilic surface enhancement comprises an alkaline treatment or a polyvinyl alcohol in an alkaline medium.

9. The inlet heat exchanger of claim 1, wherein the heat exchange medium comprises pure water or fouled water.

10. The inlet heat exchanger of claim 1, wherein the plurality of media sheets comprises a first media sheet and a second media sheet.

11. The inlet heat exchanger of claim 10, wherein the first media sheet and the second media sheet comprise a substantially similar shape.

12. The inlet heat exchanger of claim 10, wherein the first media sheet and the second media sheet comprise a face to face position.

13. The inlet heat exchanger of claim 12, wherein the face to face position comprises a plurality of airflow passages therethrough.

14. The inlet heat exchanger of claim 13, wherein the plurality of air flow passages cause the inlet air flow to twist and swirl therein to increase heat and mass transfer.

15. A method of cooling an inlet air flow into a gas turbine engine, comprising:
positioning a media pad with a substantially three-dimensional contoured shape made from non-woven synthetic fibers about an inlet of the gas turbine engine;
flowing pure water from a top to a bottom of the media pad; and
exchanging heat between the inlet air flow and the flow of pure water.

16. An inlet heat exchanger for cooling an inlet air flow in a compressor of a gas turbine engine, comprising:
a media pad;
the media pad comprising a first media sheet and a second media sheet;
the first media sheet and the second media sheet comprising a substantially three-dimensional contoured shape made from non-woven synthetic fibers;
the first media sheet and the second media sheet comprise a substantially similar shape; and
a flow of water;
the water flowing from a top to a bottom of the media pad to exchange heat with the inlet air flow.

17. The inlet heat exchanger of claim 16, wherein the substantially three-dimensional contoured shape comprises a substantially sinusoidal shape extending in a first direction and a second direction.

18. The inlet heat exchanger of claim 16, wherein the non-woven synthetic fibers comprise a polyethylene terephthalate (PET) or a polytrimethylene terephthalate (PTT).

19. The inlet heat exchanger of claim 16, wherein the non-woven synthetic fibers comprise a hydrophilic surface enhancement.

20. The inlet heat exchanger of claim 16, wherein the flow of water comprises pure water.
